(19) United States
(12) Patent Application Publication
(10) Pub. No.: US 2024/0233139 A1
(43) Pub. Date: Jul. 11, 2024

(54) ESTIMATION APPARATUS, DRIVE METHOD OF ESTIMATION APPARATUS, AND PROGRAM

(71) Applicant: FUJIFILM Corporation, Tokyo (JP)

(72) Inventor: Yuma KOMIYA, Saitama-shi (JP)

(73) Assignee: FUJIFILM Corporation, Tokyo (JP)

(21) Appl. No.: 18/610,244

(22) Filed: Mar. 19, 2024

Related U.S. Application Data
(63) Continuation of application No. PCT/JP2022/027948, filed on Jul. 15, 2022.

(30) Foreign Application Priority Data
Sep. 27, 2021 (JP) 2021-157100

(51) Int. Cl. G06T 7/20; G06T 7/70; H04N 23/69

(52) U.S. Cl. CPC G06T 7/20; G06T 7/70; H04N 23/69

(57) ABSTRACT

The estimation apparatus includes a processor that is configured to execute: a decision process of deciding on a tracking subject of a tracking target; a first creation process of creating a first reference image for a first model including the tracking subject and a second reference image for a second model including the tracking subject based on a imaging signal; a selection process of selecting one of the first model or the second model as a selected model based on factor information; an input process of inputting a captured image represented by the imaging signal into the selected model; and an estimation process of estimating a position of the tracking subject from within the captured image by using the selected model and a reference image for the selected model out of the first reference image and the second reference image.

### CROSS-REFERENCE TO RELATED APPLICATION

This application is a continuation application of International Application No. PCT/JP2022/027948, filed Jul. 15, 2022, the disclosure of which is incorporated herein by reference in its entirety. Further, this application claims priority from Japanese Patent Application No. 2021-157100 filed on Sep. 27, 2021, the disclosure of which is incorporated herein by reference in its entirety.

### BACKGROUND

### 1. Technical Field

The technology of the present disclosure relates to an estimation apparatus, a drive method of an estimation apparatus, and a program.

### 2. Description of the Related Art

JP2020-038410A discloses a solid-state imaging apparatus comprising a deep neural network (DNN) processing unit that executes DNN on an input image based on a DNN model, and a DNN control unit that receives control information generated based on evaluation information of an execution result of the DNN and changes the DNN model based on the control information.

JP2019-118097A discloses an imaging method including a selection step of performing processing of selecting any learning model from among a plurality of learning models that have learned a criterion for recording an image generated by an imaging element, a determination step of using the selected learning model to perform a determination process of whether or not the image generated by the imaging element satisfies the criterion, and a recording step of recording the image generated by the imaging element in a memory in a case where it is determined in the determination process that the image generated by the imaging element satisfies the criterion. The processing of selecting any one of the learning models is performed based on at least any of an imaging instruction from a user, an evaluation result of the image from the user, an environment in a case where the image is generated by the imaging element, or scores of the plurality of learning models for the image generated by the imaging element.

### SUMMARY

One embodiment according to the technology of the present disclosure provides an estimation apparatus, a drive method of an estimation apparatus, and a program that enable both achievements of subject tracking accuracy and real-time performance.

In order to achieve the above-described object, according to the present disclosure, there is provided an estimation apparatus comprising: a memory that stores a first model and a second model that have been trained through machine learning for subject tracking; and a processor that receives an imaging signal from an imaging element, in which the processor is configured to execute: a decision process of deciding on a tracking subject of a tracking target; a first creation process of creating a first reference image for the first model including the tracking subject and a second reference image for the second model including the tracking subject based on the imaging signal; a selection process of selecting one of the first model or the second model as a selected model based on factor information; an input process of inputting a captured image represented by the imaging signal into the selected model; and an estimation process of estimating a position of the tracking subject from within the captured image by using the selected model and a reference image for the selected model out of the first reference image and the second reference image.

It is preferable that the second model has a larger number of layers or a larger layer size than that of the first model.

It is preferable that the second reference image has a higher resolution than that of the first reference image.

It is preferable that the factor information is a type of the tracking subject, a movement speed of the tracking subject, or a degree of morphological change in the tracking subject.

It is preferable that the factor information is a value of a frame rate of the captured image to be input to the selected model.

It is preferable that the processor is configured to: execute a second creation process of creating the first reference image and not creating the second reference image, instead of the first creation process; and select the first creation process or the second creation process based on the value of the frame rate.

It is preferable that the processor is configured to: execute a first update process of updating the first reference image and the second reference image in a case where the selected model is switched from one of the first model or the second model to the other in the selection process.

It is preferable that the processor is configured to: execute a second update process of updating the first reference image and the second reference image based on a change in size of the tracking subject within an angle of view of the captured image.

It is preferable that the processor is configured to: execute the second update process based on a change in imaging magnification of an imaging apparatus including the imaging element.

According to the present disclosure, there is provided a drive method of an estimation apparatus including a memory that stores a first model and a second model that have been trained through machine learning for subject tracking, the drive method comprising: a reception step of receiving an imaging signal from an imaging element; a decision step of deciding on a tracking subject of a tracking target; a first creation step of creating a first reference image for the first model including the tracking subject and a second reference image for the second model including the tracking subject based on the imaging signal; a selection step of selecting one of the first model or the second model as a selected model based on factor information; an input step of inputting a captured image represented by the imaging signal into the selected model; and an estimation step of estimating a position of the tracking subject from within the captured image by using the selected model and a reference image for the selected model out of the first reference image and the second reference image.

According to the present disclosure, there is provided a program for operating an estimation apparatus including a memory that stores a first model and a second model that have been trained through machine learning for subject tracking, the program causing the estimation apparatus to execute: a reception process of receiving an imaging signal from an imaging element; a decision process of deciding on a tracking subject of a tracking target; a first creation process of creating a first reference image for the first model including the tracking subject and a second reference image for the second model including the tracking subject based on the imaging signal; a selection process of selecting one of the first model or the second model as a selected model based on factor information; an input process of inputting a captured image represented by the imaging signal into the selected model; and an estimation process of estimating a position of the tracking subject from within the captured image by using the selected model and a reference image for the selected model out of the first reference image and the second reference image.

### BRIEF DESCRIPTION OF THE DRAWINGS

Exemplary embodiments according to the technique of the present disclosure will be described in detail based on the following figures, wherein:

FIG. 1 is a diagram showing an example of an internal configuration of an imaging apparatus,

FIG. 2 is a block diagram showing an example of a functional configuration of a processor,

FIG. 3 is a diagram conceptually showing an example of a decision process of a tracking subject and a creation process of a reference image,

FIG. 4 is a diagram showing an example of a configuration of a first model,

FIG. 5 is a diagram showing an example of a configuration of a second model,

FIG. 6 is a diagram showing an example of training data used in machine learning of the first model,

FIG. 7 is a diagram showing an example of training data used in machine learning of the second model,

FIG. 8 is a diagram showing an example of a score map,

FIG. 9 is a flowchart illustrating a processing procedure of a subject tracking function,

FIG. 10 is a diagram showing an example in which an image cut out from a captured image is used as a search image,

FIG. 11 is a flowchart showing a creation process of a reference image according to a modification example,

FIG. 12 is a flowchart illustrating a processing procedure of the subject tracking function according to the modification example,

FIG. 13 is a flowchart showing an example of a processing procedure of a first update process,

FIG. 14 is a flowchart showing another example of the processing procedure of the first update process, and

FIG. 15 is a flowchart showing an example of a processing procedure of a second update process.

### DETAILED DESCRIPTION

An example of an embodiment according to the technology of the present disclosure will be described with reference to the accompanying drawings.

First, the terms used in the following description will be described.

In the following description, “IC” is an abbreviation of “integrated circuit”. “CPU” is an abbreviation of “central processing unit”. “ROM” is an abbreviation of “read only memory”. “RAM” is an abbreviation of “random access memory”. “CMOS” is an abbreviation of “complementary metal oxide semiconductor”.

“FPGA” is an abbreviation of “field programmable gate array”. “PLD” is an abbreviation of “programmable logic device”. “ASIC” is an abbreviation of “application specific integrated circuit”. “OVF” is an abbreviation of “optical view finder”. “EVF” is an abbreviation of “electronic view finder”. “JPEG” is an abbreviation of “joint photographic experts group”. “CNN” is an abbreviation of “convolutional neural network”.

As an embodiment of an imaging apparatus, the technology of the present disclosure will be described using a lens-interchangeable digital camera as an example. It should be noted that the technology of the present disclosure is not limited to the lens-interchangeable type and can also be applied to a digital camera with an integrated lens.

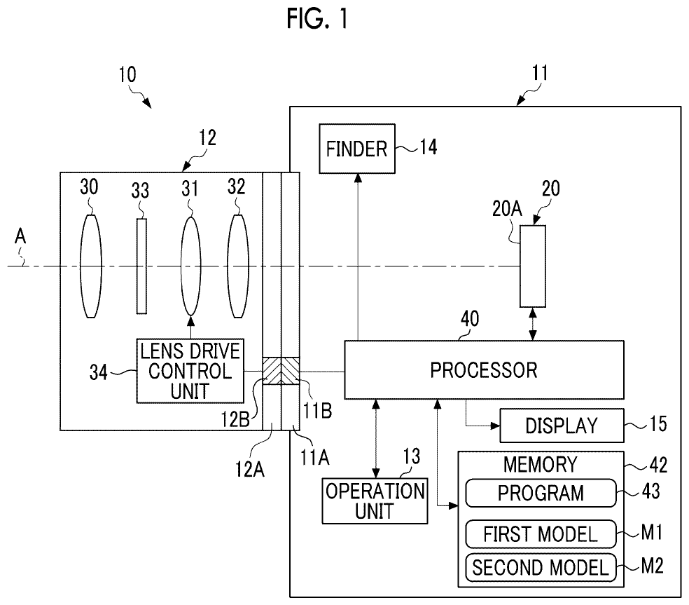

FIG. 1 shows an example of a configuration of an imaging apparatus 10. The imaging apparatus 10 is a lens-interchangeable digital camera. The imaging apparatus 10 is composed of a body 11 and an imaging lens 12 that is interchangeably mounted on the body 11. The imaging lens 12 is attached to a front surface side of the body 11 via a camera-side mount 11A and a lens-side mount 12A.

The body 11 is provided with an operation unit 13 including a dial, a release button, and the like. Examples of an operation mode of the imaging apparatus 10 include a still image capturing mode, a video capturing mode, and an image display mode. The operation unit 13 is operated by a user in a case of setting the operation mode. In addition, the operation unit 13 is operated by the user in a case of starting the execution of still image capturing or video capturing. The operation unit 13 includes a touch panel provided in a display 15, which will be described below, or the like.

In addition, the imaging apparatus 10 is provided with a subject tracking function of tracking a subject designated by the user as a tracking target in the video capturing mode. The subject tracking function can also be operated during the live view image display executed before the still image capturing or the video capturing. The imaging apparatus 10 is an example of an “estimation apparatus” according to the technology of the present disclosure.

Additionally, the body 11 is provided with a finder 14. Here, the finder 14 is a hybrid finder (registered trademark). The hybrid finder refers to a finder in which, for example, an optical view finder (hereinafter referred to as “OVF”) and an electronic view finder (hereinafter referred to as “EVF”) are selectively used. The user can observe an optical image or a live view image of the subject projected onto the finder 14 via a finder eyepiece portion (not shown).

In addition, the display 15 is provided on a rear surface side of the body 11. The display 15 displays an image based on an image signal obtained through imaging, various menu screens, or the like. Instead of the finder 14, the user can also observe the live view image projected onto the display 15.

The body 11 and the imaging lens 12 are electrically connected to each other through contact between an electrical contact 11B provided on the camera-side mount 11A and an electrical contact 12B provided on the lens-side mount 12A.

The imaging lens 12 includes an objective lens 30, a focus lens 31, a rear-end lens 32, and a stop 33. Respective members are arranged in the order of the objective lens 30, the stop 33, the focus lens 31, and the rear-end lens 32 from an objective side along an optical axis A of the imaging lens 12. The objective lens 30, the focus lens 31, and the rear-end lens 32 constitute an imaging optical system. The type, the number, and the arrangement order of the lenses constituting the imaging optical system are not limited to the example shown in FIG. 1.

Moreover, the imaging lens 12 has a lens drive control unit 34. The lens drive control unit 34 includes, for example, a CPU, a RAM, a ROM, and the like. The lens drive control unit 34 is electrically connected to a processor 40 inside the body 11 via the electrical contact 12B and the electrical contact 11B.

The lens drive control unit 34 drives the focus lens 31 and the stop 33 based on a control signal transmitted from the processor 40. The lens drive control unit 34 performs drive control of the focus lens 31 based on a control signal for focusing control transmitted from the processor 40, in order to adjust a focusing position of the imaging lens 12. The processor 40 may perform the focusing control based on an estimation result R representing the position of the tracking subject, which will be described below.

The stop 33 has an opening in which an opening diameter is variable with the optical axis A as a center. The lens drive control unit 34 performs drive control of the stop 33 based on a control signal for stop adjustment transmitted from the processor 40, in order to adjust the amount of light incident on a light-receiving surface 20A of an imaging sensor 20.

Further, the imaging sensor 20, the processor 40, and a memory 42 are provided inside the body 11. The operations of the imaging sensor 20, the memory 42, the operation unit 13, the finder 14, and the display 15 are controlled by the processor 40.

The processor 40 includes, for example, a CPU, a RAM, a ROM, and the like. In such a case, the processor 40 executes various types of processing based on a program 43 stored in the memory 42. The processor 40 may include an assembly of a plurality of IC chips.

In addition, the memory 42 stores a first model M1 and a second model M2 that have been trained through machine learning for subject tracking. Details will be described below, but the first model M1 and the second model M2 are composed of neural networks, and the second model M2 is larger in scale than the first model M1. The large scale means that the number of layers (such as convolutional layers, pooling layers, and fully connected layers) constituting the neural network is large and/or the layer size (the number of neurons constituting each layer) is large. Since the first model M1 has a small scale, the first model M1 exhibits a fast estimation process of the tracking subject but with low estimation accuracy. On the contrary, since the second model M2 has a large scale, the second model M2 exhibits a slow estimation process of the tracking subject but with high subject tracking accuracy.

The imaging sensor 20 is, for example, a CMOS-type image sensor. The imaging sensor 20 is disposed such that the optical axis A is orthogonal to the light-receiving surface 20A and the optical axis A is positioned at the center of the light-receiving surface 20A. Light (subject image) that has passed through the imaging lens 12 is incident on the light-receiving surface 20A. A plurality of pixels for generating image signals through photoelectric conversion are formed on the light-receiving surface 20A. The imaging sensor 20 generates and outputs the image signal by photoelectrically converting the light incident on each pixel. The imaging sensor 20 is an example of an “imaging element” according to the technology of the present disclosure.

Further, a Bayer array color filter array is disposed on the light-receiving surface of the imaging sensor 20, and any of a red (R), green (G), or blue (B) color filter is disposed to face each pixel. Some of the plurality of pixels arranged on the light-receiving surface of the imaging sensor 20 may be phase difference pixels for performing focusing control.

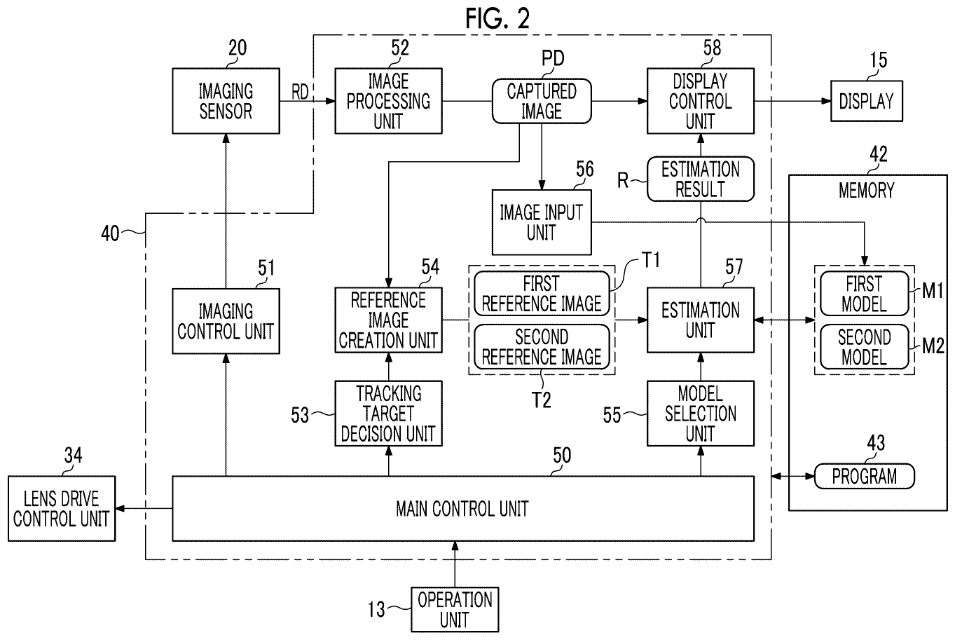

FIG. 2 shows an example of a functional configuration of the processor 40. The processor 40 implements various functional units by executing processing in accordance with the program 43 stored in the memory 42. As shown in FIG. 2, for example, a main control unit 50, an imaging control unit 51, an image processing unit 52, a tracking target decision unit 53, a reference image creation unit 54, a model selection unit 55, an image input unit 56, an estimation unit 57, and a display control unit 58 are implemented by the processor 40.

The main control unit 50 comprehensively controls operations of the imaging apparatus 10 based on instruction signals input through the operation unit 13. The imaging control unit 51 executes an imaging process of causing the imaging sensor 20 to perform an imaging operation by controlling the imaging sensor 20. The imaging control unit 51 drives the imaging sensor 20 in the still image capturing mode or the video capturing mode. The imaging sensor 20 outputs an imaging signal RD generated by the imaging operation. The imaging signal RD is so-called RAW data.

The image processing unit 52 performs a reception process of receiving the imaging signal RD output from the imaging sensor 20. In addition, the image processing unit 52 generates a captured image PD by performing image processing including a demosaicing process and the like on the received imaging signal RD. For example, the captured image PD is a color image in which each pixel is represented by three primary colors, that is, R, G, and B. More specifically, for example, the captured image PD is a 24-bit color image in which each signal of R, G, and B included in one pixel is represented by 8 bits.

The tracking target decision unit 53 performs a decision process of deciding on the subject designated by the user as the tracking target. For example, the user uses the operation unit 13 to designate a subject that the user wants to designate as the tracking target from within the captured image PD displayed on the display 15. The tracking target decision unit 53 decides on the subject designated by the user from within the captured image PD as the tracking subject of the tracking target.

In a case where the imaging apparatus 10 has a subject detection function of detecting the subject based on the captured image PD, the tracking target decision unit 53 may decide on a specific subject detected by the subject detection function as the tracking subject.

The reference image creation unit 54 performs a creation process of creating a first reference image T1 for the first model including the tracking subject decided on by the tracking target decision unit 53, and a second reference image T2 for the second model including the tracking subject, based on the captured image PD. The creation process in the present embodiment corresponds to a “first creation process” according to the technology of the present disclosure.

The reference image creation unit 54 creates the first reference image T1 and the second reference image T2 by cutting out a region including the tracking subject from within the captured image PD. Since the second reference image T2 is a reference image for the second model M2 whose scale is larger than that of the first model M1, the second reference image T2 has a higher resolution than that of the first reference image T1. A high resolution means that the amount of information is large, such as the number of pixels of the image being large, the amount of data of high-frequency components being large, and the number of bits of each pixel constituting the image being large. Hereinafter, in a case where the first reference image T1 and the second reference image T2 are not distinguished from each other, the first reference image T1 and the second reference image T2 are simply referred to as a reference image. The reference image is a so-called template.

The model selection unit 55 performs a selection process of selecting one of the first model M1 or the second model M2 stored in the memory 42 as a selected model based on factor information. In the present embodiment, the model selection unit 55 performs the selection process by using a value of a frame rate as the factor information. The frame rate refers to a reciprocal of a repetition period of the imaging operation by the imaging sensor 20.

The value of the frame rate is changed, for example, through a setting operation using the operation unit 13 by the user. Additionally, in a case where a composite mode for combining images from a plurality of frames is selected in order to increase the brightness of the image, a decrease in the value of the frame rate may occur.

The first model M1 is suitable for tracking a subject having a small change in shape or a small amount of blur between frames because the first model M1 exhibits a fast estimation process but low estimation accuracy. In a case where the frame rate is high, a fast subject tracking process becomes necessary, while a difference in time between frames is small, and the change in shape of the subject or the amount of blur is small. Therefore, the model selection unit 55 selects the first model M1 as the selected model.

On the other hand, the second model M2 is suitable for tracking a subject having a large change in shape or a large amount of blur between frames because the second model M2 exhibits a slow estimation process but high estimation accuracy. In a case where the frame rate is low, a fast subject tracking process is not necessary, while the difference in time between frames becomes large, and the change in shape of the subject or the amount of blur becomes large. Therefore, the model selection unit 55 selects the second model M2 as the selected model.

The image input unit 56 performs an input process of inputting the captured image PD represented by the imaging signal RD into the selected model selected by the model selection unit 55. In the present embodiment, the captured image PD input by the image input unit 56 to the selected model is a search image for searching for the tracking subject included in the reference image.

Further, the image input unit 56 changes the resolution of the captured image PD to be input to the selected model according to the resolution of the reference image input to the selected model. In a case where the selected model is the second model M2, the image input unit 56 sets the resolution of the captured image PD to be higher than that in a case where the selected model is the first model M1.

The estimation unit 57 performs an estimation process of estimating the position of the tracking subject from within the captured image PD by using the selected model selected by the model selection unit 55 and the reference image for the selected model. Specifically, in a case where the model selection unit 55 selects the first model M1, the estimation unit 57 inputs the first reference image T1 into the selected model. On the other hand, in a case where the model selection unit 55 selects the second model M2, the estimation unit 57 inputs the second reference image T2 into the selected model.

The selected model outputs a score map SM representing a degree of similarity between each region within the captured image PD and the reference image. The estimation unit 57 outputs information on a position having a highest score (that is, having a highest degree of similarity) in the score map SM to the display control unit 58 as the estimation result R of the position of the tracking subject.

The display control unit 58 displays the estimation result R on the display 15 together with the captured image PD. Specifically, the display control unit 58 displays the position of the tracking subject in the captured image PD in a recognizable manner based on the estimation result R. For example, the display control unit 58 displays a rectangular frame surrounding the tracking subject in the captured image PD.

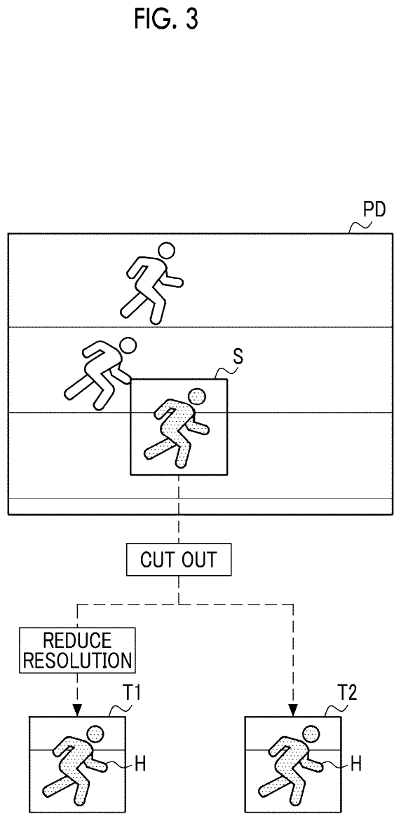

FIG. 3 conceptually shows an example of the decision process of the tracking subject and the creation process of the reference image. In FIG. 3, a region S is a region designated by the user as the tracking target from within the captured image PD using the operation unit 13. The tracking target decision unit 53 decides on the subject included in the designated region S as a tracking subject H.

The reference image creation unit 54 cuts out the region including the tracking subject H from the captured image PD and reduces the resolution of the cutout image to create the first reference image T1 (in other words, the resolution of the second reference image T2 is higher than the resolution of the first reference image T1). In addition, the reference image creation unit 54 cuts out the region including the tracking subject H from the captured image PD to create the second reference image T2.

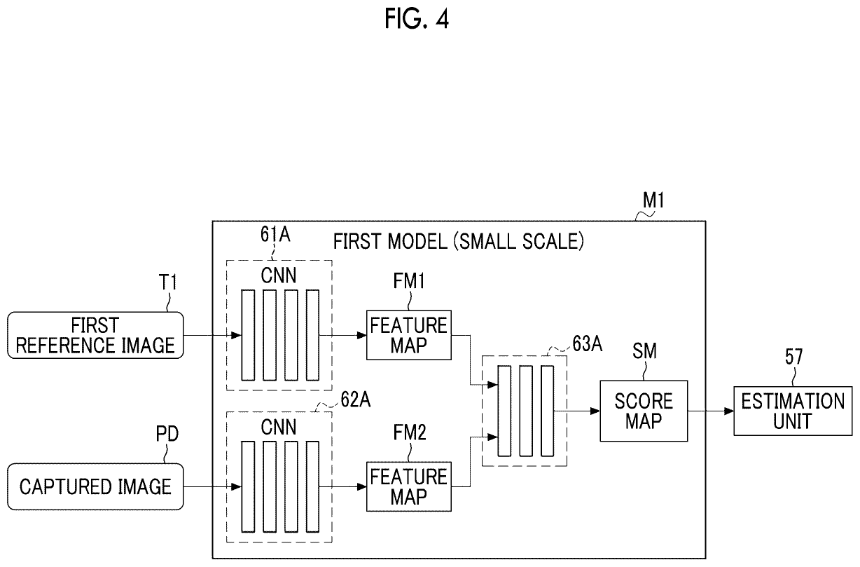

FIG. 4 shows an example of a configuration of the first model M1. The first model M1 is composed of a first convolution network (hereinafter referred to as a first CNN) 61A, a second convolution network (hereinafter referred to as a second CNN) 62A, and a convolutional operation unit 63A.

The first CNN 61A is composed of a plurality of convolutional layers and a plurality of pooling layers. Similarly, the second CNN 62A is composed of a plurality of convolutional layers and a plurality of pooling layers. The convolutional operation unit 63A is composed of a plurality of fully connected layers.

The first reference image T1 is input to the first CNN 61A. The captured image PD is input to the second CNN 62A. The first CNN 61A converts the input first reference image T1 into a feature map FM1 and outputs the feature map FM1. The second CNN 62A converts the input captured image PD into a feature map FM2 and outputs the feature map FM2. The feature map FM1 and the feature map FM2 are input to the convolutional operation unit 63A.

The first CNN 61A and the second CNN 62A have the same configuration, but an input layer to which the image is input has a size corresponding to the size (the number of neurons) of the input image. That is, the size of the input layer is different between the first CNN 61A and the second CNN 62A.

The convolutional operation unit 63A generates the score map SM by applying convolution to the feature map FM2 using the feature map FM1 as a kernel and outputs the generated score map SM to the estimation unit 57. The score map SM is an image representing the degree of similarity between each region of the captured image PD and the first reference image T1. The higher the degree of similarity is, the higher the score is.

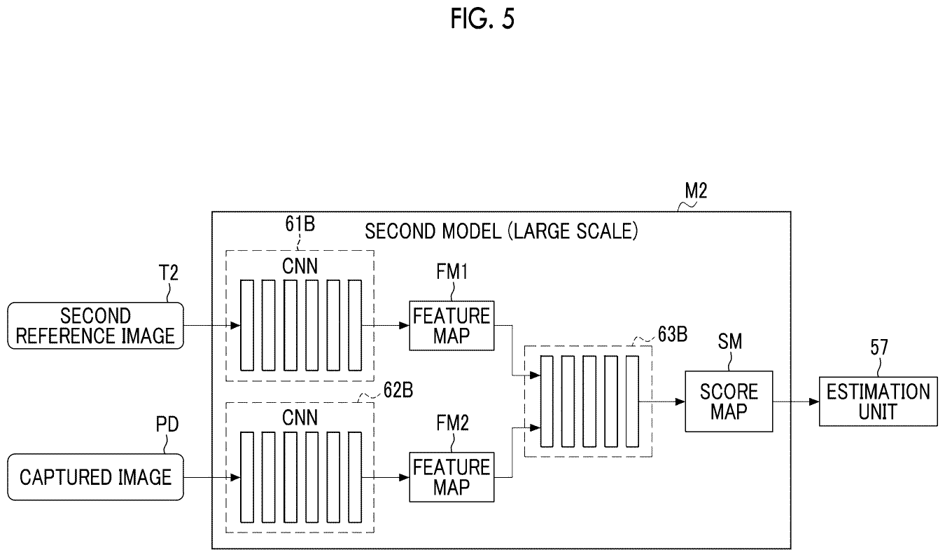

FIG. 5 shows an example of a configuration of the second model M2. The second model M2 is composed of a first CNN 61B, a second CNN 62B, and a convolutional operation unit 63B. The first CNN 61B, the second CNN 62B, and the convolutional operation unit 63B have larger numbers of layers than those of the first CNN 61A, the second CNN 62A, and the convolutional operation unit 63A, respectively. The first CNN 61B, the second CNN 62B, and the convolutional operation unit 63B may have larger layer sizes than those of the first CNN 61A, the second CNN 62A, and the convolutional operation unit 63A, respectively.

The second model M2 has the same configuration as the first model M1, except that the number of layers is large and/or the layer size is large. A large number of layers means that the number of convolutional operation layers or pooling layers is large. Further, a large layer size means that the number of operations or the amount of operation in the convolutional operation layer or the pooling layer is large.

The second reference image T2 is input to the first CNN 61B. The captured image PD is input to the second CNN 62B. The first CNN 61B converts the input second reference image T2 into the feature map FM1 and outputs the feature map FM1. The second CNN 62B converts the input captured image PD into the feature map FM2 and outputs the feature map FM2. The feature map FM1 and the feature map FM2 are input to the convolutional operation unit 63B.

The convolutional operation unit 63B generates the score map SM by applying convolution to the feature map FM2 using the feature map FM1 as a kernel and outputs the generated score map SM to the estimation unit 57.

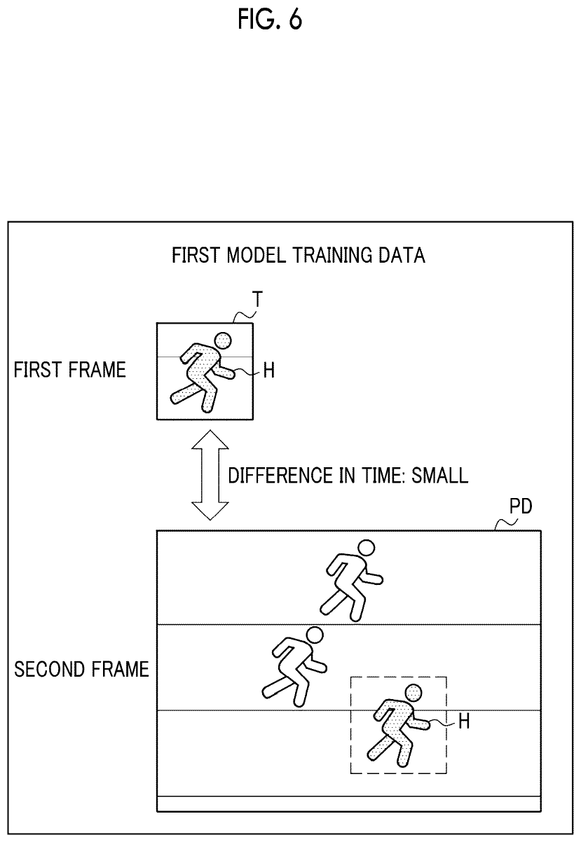

FIG. 6 shows an example of training data used in the machine learning of the first model M1. The machine learning of the first model M1 is performed by using two frames selected from within a video as one set. Specifically, machine learning is performed by inputting, into the first model M1, training data using the first reference image T1 generated from a first frame and the captured image PD generated from a second frame as one set. It is preferable for the machine learning of the first model M1 to use two frames in which the difference in time is small and the change in shape of the subject is small.

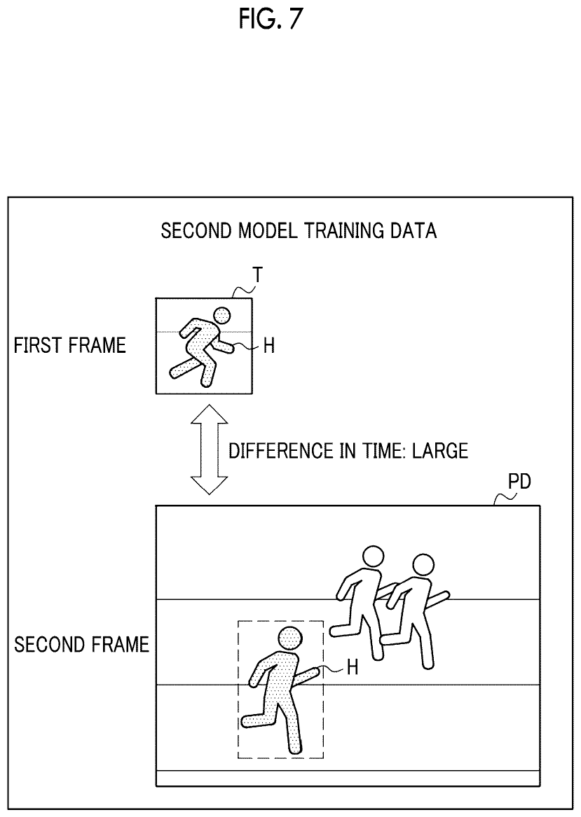

FIG. 7 shows an example of training data used in the machine learning of the second model M2. The machine learning of the second model M2 is performed by using two frames selected from within the video as one set. Specifically, machine learning is performed by inputting, into the second model M2, training data using the second reference image T2 generated from the first frame and the captured image PD generated from the second frame as one set. It is preferable for the machine learning of the second model M2 to use two frames in which the difference in time is large and the change in shape of the subject is large.

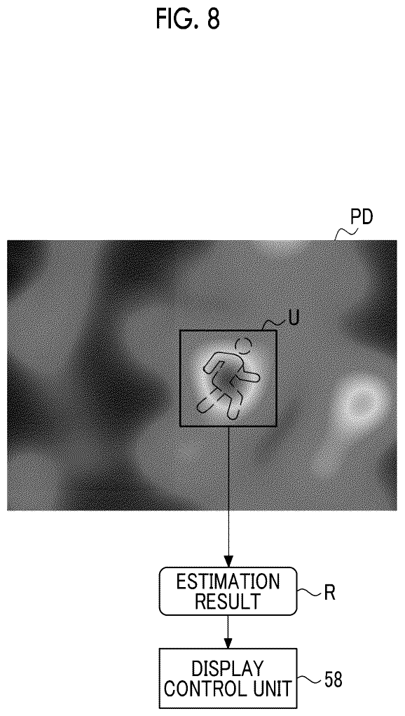

FIG. 8 shows an example of the score map SM. As shown in FIG. 8, the estimation unit 57 specifies, for example, a region U including a position having the highest score in the score map SM and outputs position information of the specified region U to the display control unit 58 as the estimation result R.

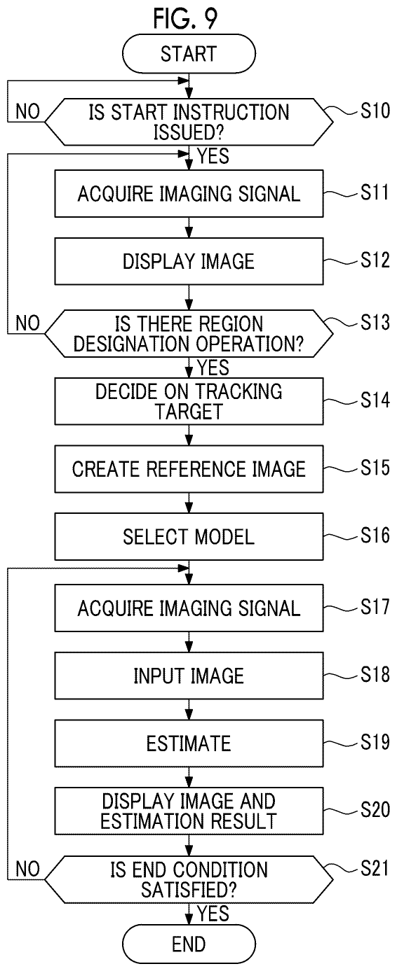

FIG. 9 is a flowchart illustrating a processing procedure of the subject tracking function during the video capturing or the live view image display.

The main control unit 50 determines whether or not a start instruction of the video capturing or the live view image display is issued by the user through the operation of the operation unit 13 (step S10). In a case where the start instruction is issued (step S10: YES), the main control unit 50 controls the imaging control unit 51 to cause the imaging sensor 20 to perform the imaging operation, and acquires the imaging signal RD output from the imaging sensor 20 (step S11). The display control unit 58 displays the captured image PD generated by the image processing unit 52 on the display 15 based on the imaging signal RD (step S12).

The main control unit 50 determines whether or not the user has designated the region, which is the tracking target, from within the captured image PD by using the operation unit 13 (step S13). In a case where the user has not designated the region (step S13: NO), the main control unit 50 returns the processing to step S11 and causes the imaging sensor 20 to perform the imaging operation. The processing of steps S11 and S12 is repeatedly executed until it is determined in step S13 that the user has designated the region.

In a case where the user has designated the region (step S13: YES), the main control unit 50 causes the tracking target decision unit 53 to decide on the tracking target (step S14). In step S14, the tracking target decision unit 53 decides on the subject included in the designated region as the tracking subject H.

The reference image creation unit 54 cuts out the region including the tracking subject H from the captured image PD to create the first reference image T1 and the second reference image T2 (step S15). Here, the second reference image T2 has a higher resolution than that of the first reference image T1.

The model selection unit 55 selects any of the first model M1 or the second model M2 as the selected model by using the value of the frame rate as the factor information (step S16). In step S16, the model selection unit 55 selects the first model M1 as the selected model in a case where the value of the frame rate is equal to or greater than a certain value, and selects the second model M2 as the selected model in a case where the value of the frame rate is less than the certain value.

The main control unit 50 controls the imaging control unit 51 to cause the imaging sensor 20 to perform the imaging operation, and acquires the imaging signal RD output from the imaging sensor 20 (step S17). The image input unit 56 inputs the captured image PD generated by the image processing unit 52 based on the imaging signal RD to the selected model as the resolution corresponding to the selected model selected by the model selection unit 55 (step S18).

The estimation unit 57 inputs the reference image for the selected model selected by the model selection unit 55, out of the first reference image T1 and the second reference image T2, to the selected model, estimates the position of the tracking subject from the imaging signal RD based on the score map SM output from the selected model, and outputs the estimation result R to the display control unit 58 (step S19). The display control unit 58 displays the estimation result R on the display 15 together with the captured image PD (step S20).

The main control unit 50 determines whether or not a predetermined end condition is satisfied (step S21). The end condition is, for example, that the user performs an operation to stop the video capturing by using the operation unit 13. In a case where the end condition is not satisfied (step S21: NO), the main control unit 50 returns the processing to step S17 and causes the imaging sensor 20 to perform the imaging operation. The processing of steps S17 to S20 is repeatedly executed until it is determined in step S21 that the end condition is satisfied. In a case where the end condition is satisfied (step S21: YES), the main control unit 50 ends the processing.

In the flowchart, steps S11 and S17 correspond to a “reception step” according to the technology of the present disclosure. Step S14 corresponds to a “decision step” according to the technology of the present disclosure. Step S15 corresponds to a “first creation step” according to the technology of the present disclosure. Step S16 corresponds to a “selection step” according to the technology of the present disclosure. Step S18 corresponds to an “input step” according to the technology of the present disclosure. Step S19 corresponds to an “estimation step” according to the technology of the present disclosure.

As described above, according to the technology of the present disclosure, the small-scale first model M1 is selected with emphasis on the real-time performance in a case where the frame rate is high, and the large-scale second model M2 is selected with emphasis on the subject tracking accuracy in a case where the frame rate is low. In a case where the frame rate is high, the subject tracking accuracy is constantly maintained even with the small-scale first model M1 because the change in shape of the tracking subject or the amount of blur is small between frames. Further, in a case where the frame rate is low, the real-time performance is constantly maintained even with the large-scale second model M2 because the frame period is long. As described above, according to the technology of the present disclosure, both the subject tracking accuracy and the real-time performance can be achieved.

Further, according to the technology of the present disclosure, since the first reference image T1 for the first model M1 and the second reference image T2 for the second model M2 are created, and the estimation process is performed using the reference image corresponding to the selected model, there is no need to re-create the reference image in a case of switching the selected model. Therefore, the real-time performance can be maintained even in a case where the selected model is switched.

### MODIFICATION EXAMPLE

Hereinafter, various modification examples of the above-described embodiment will be described. In each modification example, only the difference from the above-described embodiment will be described.

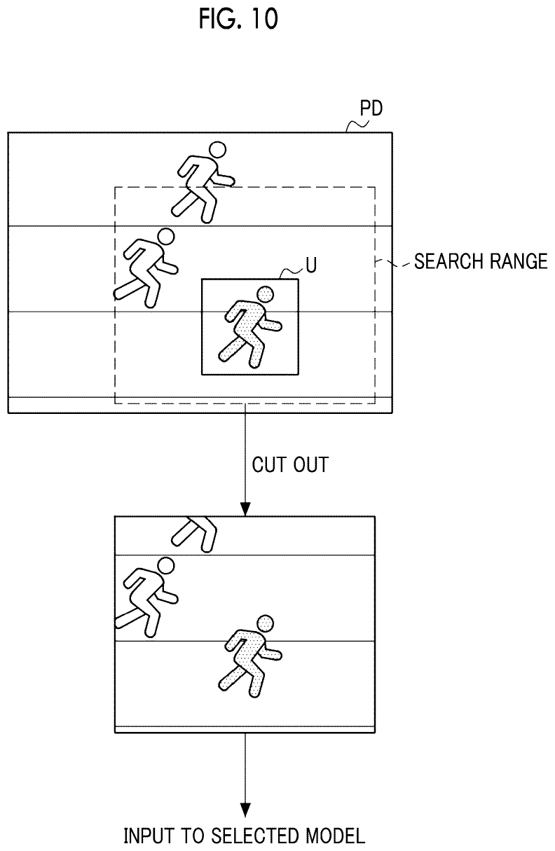

In the above-described embodiment, the image input unit 56 inputs the entire captured image PD to the selected model as the search image, but the image cut out from the captured image PD may be input to the selected model as the search image. For example, as shown in FIG. 10, the image input unit 56 sets a search range to include the region U including the tracking subject estimated by the estimation unit 57 in the previous frame period of time, and cuts out an image within the search range from the captured image PD obtained in the current frame period to input the cutout image to the selected model. In this way, by limiting the search range, a processing speed by the selected model is improved.

### Creation of Reference Image

In the above-described embodiment, the reference image creation unit 54 executes the creation process (first creation process) of creating the first reference image T1 and the second reference image T2 from the captured image PD. The reference image creation unit 54 may be configured to execute a second creation process of creating the first reference image T1 and not creating the second reference image T2, instead of the first creation process. For example, the reference image creation unit 54 selectively executes the first creation process or the second creation process based on the value of the frame rate.

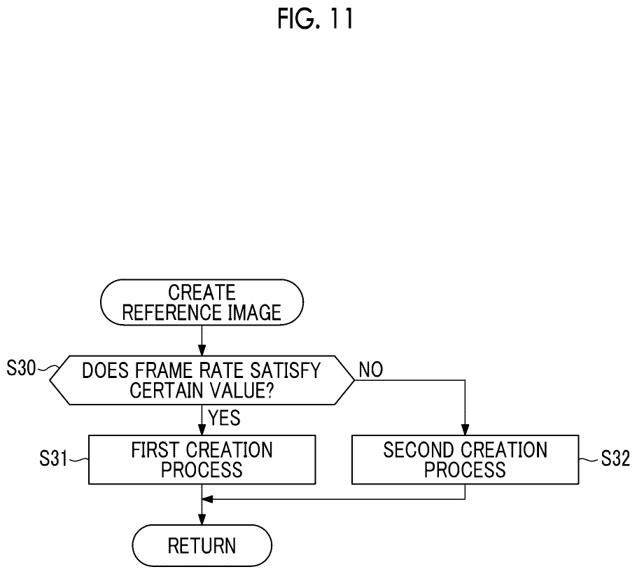

FIG. 11 shows the creation process of the reference image according to a modification example. The processing shown in FIG. 11 is executed, for example, in step S15 of the flowchart shown in FIG. 9. The reference image creation unit 54 determines whether or not the value of the frame rate is less than a certain value (step S30). In a case where the value of the frame rate is less than the certain value (step S30: YES), the reference image creation unit 54 executes the first creation process (step S31). On the other hand, in a case where the value of the frame rate is equal to or greater than the certain value (step S30: NO), the reference image creation unit 54 executes the second creation process (step S32).

That is, the first creation process is executed in a case where the second model M2 is selected as the selected model by the model selection unit 55, and the second creation process is executed in a case where the first model M1 is selected as the selected model by the model selection unit 55. In a case where the frame rate is high, processing can be expedited without creating the second reference image T2.

### Selection of Model

In the above-described embodiment, the model selection unit 55 performs the selection process by using the value of the frame rate as the factor information, but the factor information is not limited to the value of the frame rate. For example, the model selection unit 55 may perform the selection process by using the type of the tracking subject decided on by the tracking target decision unit 53 as the factor information.

The first model M1 is suitable for tracking the subject having a small change in shape between frames because the first model M1 exhibits a fast estimation process but low estimation accuracy. The subject having a small change in shape between frames is an object having high stiffness, and is, for example, a vehicle, an aerial vehicle, and the like. On the other hand, the second model M2 is suitable for tracking the subject having a large change in shape between frames because the second model M2 exhibits a slow estimation process but high estimation accuracy. The subject having a large change in shape between frames is an object having low stiffness, and is, for example, a human, an animal, and the like. The human, the animal, and the like are prone to changes in shape due to movements such as limbs.

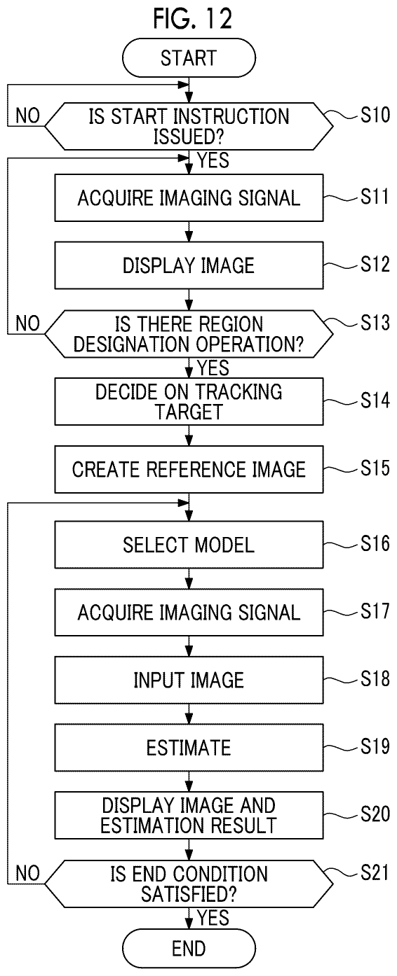

In the above-described embodiment, the selected model is not changed after the model selection unit 55 performs the selection process of the selected model, but the selected model may be changed according to the factor information that changes during the tracking operation of the subject. For example, as in the flowchart shown in FIG. 12, in a case where the end condition is not satisfied (step S21: NO), the main control unit 50 returns the processing to step S16 and causes the model selection unit 55 to execute the selection process of the selected model again. In this way, the model selection unit 55 may repeatedly execute the selection process until the end condition is satisfied.

In this case, it is preferable that the model selection unit 55 performs the selection process by using the movement speed of the tracking subject as the factor information. In a case where the movement speed of the tracking subject is high, the change in shape of the tracking subject or the like becomes large between frames. Therefore, it is preferable that the model selection unit 55 selects the second model M2 as the selected model in a case where the movement speed of the tracking subject is equal to or greater than a certain value, and selects the first model M1 as the selected model in a case where the movement speed of the tracking subject is less than the certain value.

In addition, it is also preferable that the model selection unit 55 performs the selection process by using a degree of morphological change of the tracking subject as the factor information. The degree of morphological change of the tracking subject is, for example, a degree of change in shape or a degree of change in color. It is preferable that the model selection unit 55 selects the second model M2 as the selected model in a case where the degree of morphological change of the tracking subject between frames is equal to or greater than a certain value, and selects the first model M1 as the selected model in a case where the degree of morphological change of the tracking subject between frames is less than the certain value.

In addition, it is also preferable that the model selection unit 55 performs the selection process by using the score obtained from the score map SM output from the selected model as the factor information. For example, in a case where the first model M1 is selected as the selected model and the maximum value of the score is less than a threshold value, the model selection unit 55 determines that the tracking accuracy has decreased, and selects the second model M2 having high tracking accuracy as the selected model.

### Update of Reference Image

In the above-described embodiment, in order to expedite the subject tracking operation, the reference image created by the reference image creation unit 54 is not updated until the subject tracking operation ends. This is because updating the reference image during subject tracking operation, especially in a case where postural changes such as rotation have occurred in the tracking subject or in a case where occlusion (that is, intersection of objects) has occurred, increases the probability of incorrectly tracking the object other than the tracking subject. Here, the update means that the reference image creation unit 54 creates a new reference image.

As described above, in principle, it is preferable not to update the reference image, but the reference image creation unit 54 may update the reference image in a case where a specific condition is satisfied.

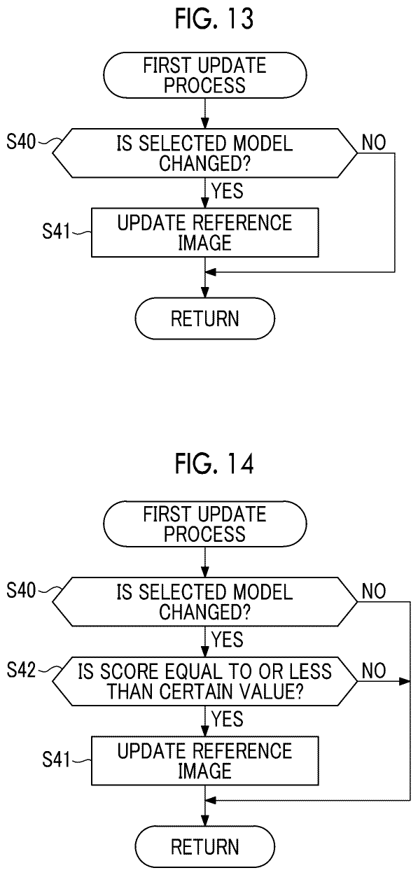

For example, the reference image creation unit 54 executes a first update process of updating the first reference image T1 and the second reference image T2 in a case where the selected model is switched from one of the first model M1 or the second model M2 to the other. Specifically, immediately after step S16 in the flowchart shown in FIG. 12, the first update process of the reference image shown in FIG. 13 is executed.

In FIG. 12, the reference image creation unit 54 determines whether or not the selected model is changed by the model selection unit 55 in step S16 (step S40). In a case where the selected model is not changed (step S40: NO), the reference image creation unit 54 does not update the reference image. On the other hand, in a case where the selected model is changed (step S40: YES), the reference image creation unit 54 updates the reference image (step S41). In step S41, the reference image creation unit 54 creates the first reference image T1 and the second reference image T2 based on an image cut out from the region U (see FIG. 8) specified by the estimation unit 57 in the captured image PD obtained in the immediately preceding frame period.

Since updating the reference image in a case where the score of the region U is low decreases the reliability of the reference image after the update, it is preferable to update the reference image on a condition that the score is equal to or greater than a certain value. For example, as shown in the flowchart of FIG. 14, in a case where the selected model is changed (step S40: YES), the reference image creation unit 54 determines whether or not the score (for example, the maximum value) of the region U specified by the estimation unit 57 is equal to or greater than the certain value (step S42). In a case where the score is not equal to or greater than the certain value (step S42: NO), the reference image creation unit 54 does not update the reference image. On the other hand, in a case where the score is equal to or greater than the certain value (step S42: YES), the reference image creation unit 54 updates the reference image (step S41).

In addition, the reference image creation unit 54 may execute a second update process of updating the reference image based on a change in size of the tracking subject within an angle of view of the captured image PD. The change in size of the tracking subject occurs, for example, in a case where the tracking subject approaches the imaging apparatus 10 or moves away from the imaging apparatus 10. In a case where the size of the tracking subject is changed, the degree of similarity to the reference image is decreased, which results in a decrease in the subject tracking accuracy. Therefore, it is preferable that the reference image creation unit 54 updates the reference image in a case where the size of the tracking subject is changed by a certain value or greater on the basis of the size of the tracking subject within the reference image. The size of the tracking subject can be detected by using a subject detection result by the subject detection function.

The size of the tracking subject within the angle of view of the captured image PD depends on a distance from the imaging apparatus 10 to the tracking subject. Therefore, the reference image creation unit 54 may update the reference image in a case where the distance from the imaging apparatus 10 to the tracking subject is changed by a certain value or greater based on distance information detected by the phase difference pixels of the imaging sensor 20.

In addition, the change in size of the tracking subject can also be caused by a change in imaging magnification of the imaging apparatus 10. Therefore, it is preferable that the reference image creation unit 54 updates the reference image in a case where the imaging magnification is changed by a certain value or greater, after creating the reference image. The imaging magnification is changed not only by the optical zoom but also by the electronic zoom. For example, the imaging magnification is changed by the user through the operation of the operation unit 13.

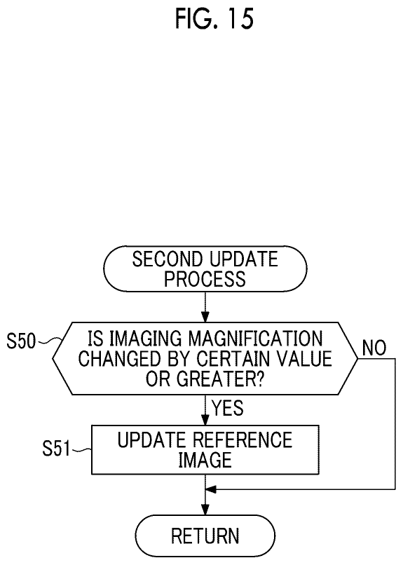

FIG. 15 is a flowchart showing an example of the second update process. The reference image creation unit 54 executes the second update process of the reference image shown in FIG. 15 during the subject tracking operation. In FIG. 15, the reference image creation unit 54 determines whether or not the imaging magnification is changed by the certain value or greater (step S50). In a case where the imaging magnification is not changed by the certain value or greater (step S50: NO), the reference image creation unit 54 does not update the reference image. On the other hand, in a case where the imaging magnification is changed by the certain value or greater (step S50: YES), the reference image creation unit 54 updates the reference image (step S51).

In the second update process as well, it is preferable that the reference image creation unit 54 updates the reference image on a condition that the score is equal to or greater than a certain value.

Furthermore, the reference image creation unit 54 may periodically update the reference image during the subject tracking operation. For example, the reference image creation unit 54 updates the reference image once every several hundred frames during the subject tracking operation. In this case as well, it is preferable that the reference image creation unit 54 updates the reference image on a condition that the score is equal to or greater than a certain value.

The technology of the present disclosure is not limited to the digital camera and can also be applied to electronic devices such as a smartphone and a tablet terminal having an imaging function.

In the above-described embodiment, various processors to be described below can be used as the hardware structure of the control unit using the processor 40 as an example. The above-described various processors include, in addition to a CPU which is a general-purpose processor that functions by executing software (programs), a processor that has a changeable circuit configuration after manufacturing, such as an FPGA. The FPGA includes a dedicated electrical circuit that is a processor which has a dedicated circuit configuration designed to execute specific processing, such as PLD or ASIC, and the like.

The control unit may be configured with one of these various processors or may be configured with a combination of two or more of the processors of the same type or different types (for example, a combination of a plurality of FPGAs or a combination of a CPU and an FPGA). Alternatively, a plurality of control units may be configured with one processor.

A plurality of examples in which a plurality of control units are configured with one processor are conceivable. As a first example, there is an aspect in which one or more CPUs and software are combined to configure one processor and the processor functions as a plurality of control units, as typified by a computer such as a client and a server. As a second example, there is an aspect in which a processor that implements the functions of the entire system, which includes a plurality of control units, with one IC chip is used, as typified by system on chip (SOC). In this way, the control unit can be configured by using one or more of the above-described various processors, as the hardware structure.

Moreover, more specifically, it is possible to use an electrical circuit in which circuit elements such as semiconductor elements are combined, as the hardware structure of these various processors.

The contents described and shown above are detailed descriptions of parts related to the technology of the present disclosure and are merely an example of the technology of the present disclosure. For example, the above description related to configurations, functions, actions, and effects is description related to an example of the configurations, functions, actions, and effects of the parts related to the technology of the present disclosure. Therefore, it goes without saying that unnecessary parts may be deleted, new elements may be added, or replacements may be made for the contents described and shown above within the scope that does not depart from the gist of the technology of the present disclosure. Moreover, in order to avoid confusion and facilitate understanding of the parts related to the technology of the present disclosure, description related to common technical knowledge and the like that do not require particular description to enable implementation of the technology of the present disclosure is omitted from the contents described and shown above.

All documents, patent applications, and technical standards described in the present specification are incorporated by reference into the present specification to the same extent as in a case where the individual documents, patent applications, and technical standards were specifically and individually stated to be incorporated by reference.

What is claimed is:

1. An estimation apparatus comprising:
a memory that stores a first model and a second model that have been trained through machine learning for subject tracking; and
a processor that receives an imaging signal from an imaging element,
wherein the processor is configured to execute:
a decision process of deciding on a tracking subject of a tracking target;
a first creation process of creating a first reference image for the first model including the tracking subject and a second reference image for the second model including the tracking subject based on the imaging signal;
a selection process of selecting one of the first model or the second model as a selected model based on factor information;
an input process of inputting a captured image represented by the imaging signal into the selected model; and
an estimation process of estimating a position of the tracking subject from within the captured image by using the selected model and a reference image for the selected model out of the first reference image and the second reference image.

2. The estimation apparatus according to claim 1,
wherein the second model has a larger number of layers or a larger layer size than that of the first model.

3. The estimation apparatus according to claim 2,
wherein the second reference image has a higher resolution than that of the first reference image.

4. The estimation apparatus according to claim 3,
wherein the factor information is a type of the tracking subject, a movement speed of the tracking subject, or a degree of morphological change in the tracking subject.

5. The estimation apparatus according to claim 3,
wherein the factor information is a value of a frame rate of the captured image to be input to the selected model.

6. The estimation apparatus according to claim 5,
wherein the processor is configured to:
execute a second creation process of creating the first reference image and not creating the second reference image, instead of the first creation process; and
select the first creation process or the second creation process based on the value of the frame rate.

7. The estimation apparatus according to claim 1,
wherein the processor is configured to:
execute a first update process of updating the first reference image and the second reference image in a case where the selected model is switched from one of the first model or the second model to the other in the selection process.

8. The estimation apparatus according to claim 1,
wherein the processor is configured to:
execute a second update process of updating the first reference image and the second reference image based on a change in size of the tracking subject within an angle of view of the captured image.

9. The estimation apparatus according to claim 8,
wherein the processor is configured to:
execute the second update process based on a change in imaging magnification of an imaging apparatus including the imaging element.

10. A drive method of an estimation apparatus including a memory that stores a first model and a second model that have been trained through machine learning for subject tracking, the drive method comprising:
a reception step of receiving an imaging signal from an imaging element;
a decision step of deciding on a tracking subject of a tracking target;
a first creation step of creating a first reference image for the first model including the tracking subject and a second reference image for the second model including the tracking subject based on the imaging signal;
a selection step of selecting one of the first model or the second model as a selected model based on factor information;
an input step of inputting a captured image represented by the imaging signal into the selected model; and
an estimation step of estimating a position of the tracking subject from within the captured image by using the selected model and a reference image for the selected model out of the first reference image and the second reference image.

11. A non-transitory computer-readable storage medium storing a program for operating an estimation apparatus including a memory that stores a first model and a second model that have been trained through machine learning for subject tracking, the program causing the estimation apparatus to execute:
a reception process of receiving an imaging signal from an imaging element;
a decision process of deciding on a tracking subject of a tracking target;
a first creation process of creating a first reference image for the first model including the tracking subject and a second reference image for the second model including the tracking subject based on the imaging signal;
a selection process of selecting one of the first model or the second model as a selected model based on factor information;
an input process of inputting a captured image represented by the imaging signal into the selected model; and
an estimation process of estimating a position of the tracking subject from within the captured image by using the selected model and a reference image for the selected model out of the first reference image and the second reference image.
